(19) United States
(12) Patent Application Publication
(10) Pub. No.: US 2026/0322500 A1
(43) Pub. Date: Oct. 15, 2026

(54) OPTICAL RECEIVER

(71) Applicant: SONY SEMICONDUCTOR SOLUTIONS CORPORATION, Kanagawa (JP)

(72) Inventor: Yoshiki EBIKO, Kanagawa (JP)

(73) Assignee: SONY SEMICONDUCTOR SOLUTIONS CORPORATION, Kanagawa (JP)

(21) Appl. No.: 19/481,056

(22) PCT Filed: May 15, 2024
(86) PCT No.: PCT/JP2024/017887

§ 371 Date: Nov. 3, 2025

(30) Foreign Application Priority Data
May 31, 2023 (JP) 2023-089847

(51) Int. Cl. H04B 10/66; G02B 6/12; G02B 6/124

(52) U.S. Cl. CPC H04B 10/66; G02B 6/124; G02B 2006/12107

(57) ABSTRACT

An optical receiver according to an embodiment of the present disclosure includes a PIC substrate and a signal processing substrate. The PIC substrate includes a first waveguide and an antenna. The first waveguide is configured to transmit a transmission signal. The antenna is configured to output the transmission signal to an outside via an entrance-and-exit surface and to receive a return signal from the outside via the entrance-and-exit surface. The PIC substrate and the signal processing substrate are stacked on each other and are electrically coupled to each other via a joining surface between the PIC substrate and the signal processing substrate. The antenna includes a first diffraction grating provided in a region between the Si layer and the entrance-and-exit surface.

### TECHNICAL FIELD

The present disclosure relates to an optical receiver.

### BACKGROUND ART

Recently, there has been developed a LiDAR (Light Detection and Ranging) system using a PIC (Photonic Integration Circuit) in which, in place of an optical fiber, an optical component such as a Si (silicon) waveguide is stacked on a SOI (Silicon On Insulator) substrate (for example, see PTL 1).

### Citation List

### Patent Literature

PTL 1: Japanese Unexamined Patent Application Publication No. 2018-186732

### SUMMARY OF THE INVENTION

In such a system, it is required to efficiently output an optical signal from a Si waveguide and to efficiently guide an optical signal outputted from a light source to the Si waveguide. It is desirable to provide an optical receiver that makes it possible to efficiently output an optical signal from a Si waveguide or an optical receiver that makes it possible to efficiently guide an optical signal outputted from a light source to the Si waveguide.

An optical receiver according to one embodiment of the present disclosure includes a PIC substrate and a signal processing substrate. The PIC substrate includes a first waveguide and an antenna. The first waveguide is configured to transmit a transmission signal. The antenna is configured to output the transmission signal to an outside via an entrance-and-exit surface and to receive a return signal from the outside via the entrance-and-exit surface. In the PIC substrate, the first waveguide and a part of the antenna are provided in a common Si (Silicon) layer, and in addition, the entrance-and-exit surface is provided at a location opposed to the antenna. The signal processing substrate is configured to process a signal generated on the basis of the return signal. The PIC substrate and the signal processing substrate are stacked on each other and are electrically coupled to each other via a joining surface between the PIC substrate and the signal processing substrate. The antenna includes a first diffraction grating provided in a region between the Si layer and the entrance-and-exit surface.

In the optical receiver according to the embodiment of the present disclosure, in the PIC substrate, the first waveguide and a part of the antenna are provided in the common Si layer. In addition, the diffraction grating is provided in a region that is at a location different from the Si layer and is between the Si layer and the entrance-and-exit surface. This allows the diffraction grating and the Si layer to be optically coupled to each other, and allows the transmission signal to be outputted from the Si layer to the outside via the entrance-and-exit surface.

### BRIEF DESCRIPTION OF THE DRAWINGS

FIG. 1 is a diagram illustrating an exemplary schematic configuration of a ranging device according to a first embodiment of the present disclosure.

FIG. 2 is a diagram illustrating an exemplary cross-sectional configuration of the ranging device in FIG. 1.

FIG. 3 is a diagram illustrating an exemplary schematic configuration of an antenna in FIG. 1.

FIG. 4 is a diagram illustrating an exemplary cross-sectional configuration of a Si antenna in FIG. 3, taken along line A-A.

FIG. 5 is a diagram illustrating an exemplary cross-sectional configuration of the Si antenna in FIG. 3, taken along line B-B.

FIG. 6 is a diagram illustrating an exemplary schematic configuration of a detector in FIG. 1.

FIG. 7 is a diagram illustrating an exemplary perspective configuration of the detector in FIG. 6.

FIG. 8A is a cross-sectional view for describing a manufacturing method of the ranging device in FIG. 1.

FIG. 8B is a cross-sectional view for describing the manufacturing method, subsequent to FIG. 8A.

FIG. 8C is a cross-sectional view for describing the manufacturing method, subsequent to FIG. 8B.

FIG. 8D is a cross-sectional view for describing the manufacturing method, subsequent to FIG. 8C.

FIG. 8E is a cross-sectional view for describing the manufacturing method, subsequent to FIG. 8D.

FIG. 8F is a cross-sectional view for describing the manufacturing method, subsequent to FIG. 8E.

FIG. 8F is a cross-sectional view for describing the manufacturing method, subsequent to FIG. 8F.

FIG. 8H is a cross-sectional view for describing the manufacturing method, subsequent to FIG. 8G.

FIG. 9 is a diagram illustrating a modification example of the cross-sectional configuration of the Si antenna in FIG. 4.

FIG. 10 is a diagram illustrating a modification example of the cross-sectional configuration of the Si antenna in FIG. 5.

FIG. 11 is a diagram illustrating a modification example of the cross-sectional configuration of the Si antenna in FIG. 4.

FIG. 12 is a diagram illustrating a modification example of the cross-sectional configuration of the Si antenna in FIG. 5.

FIG. 13 is a diagram illustrating a modification example of the cross-sectional configuration of the Si antenna in FIG. 4.

FIG. 14 is a diagram illustrating a modification example of the cross-sectional configuration of the Si antenna in FIG. 5.

FIG. 15 is a diagram illustrating an exemplary cross-sectional configuration of a ranging device according to a second embodiment of the present disclosure.

FIG. 16 is a diagram illustrating an exemplary cross-sectional configuration of a Si antenna in FIG. 15.

FIG. 17 is a diagram illustrating an exemplary cross-sectional configuration of the Si antenna in FIG. 15.

FIG. 18 is a diagram illustrating a modification example of the cross-sectional configuration of a Si antenna in FIG. 16.

FIG. 19 is a diagram illustrating a modification example of the cross-sectional configuration of a Si antenna in FIG. 17.

FIG. 20 is a diagram illustrating a modification example of the cross-sectional configuration of the Si antenna in FIG. 16.

FIG. 21 is a diagram illustrating a modification example of the cross-sectional configuration of the Si antenna in FIG. 17.

FIG. 22 is a diagram illustrating a modification example of the cross-sectional configuration of the Si antenna in FIG. 16.

FIG. 23 is a diagram illustrating a modification example of the cross-sectional configuration of the Si antenna in FIG. 17.

FIG. 24 is a block diagram depicting an example of schematic configuration of a vehicle control system.

FIG. 25 is a diagram of assistance in explaining an example of installation positions of an outside-vehicle information detecting section and an imaging section.

### MODES FOR CARRYING OUT THE INVENTION

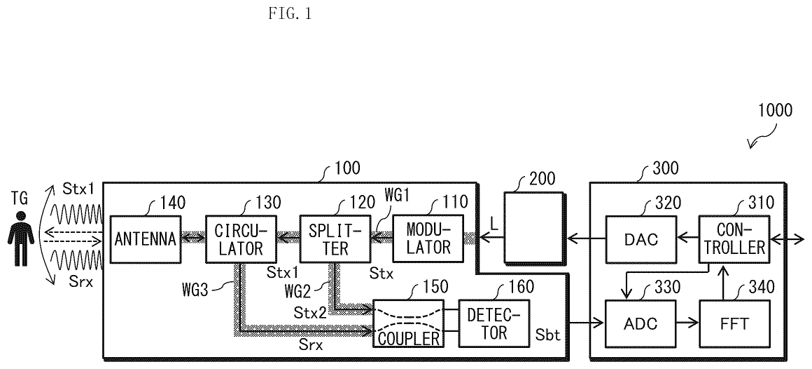

In the following, some embodiments of the present disclosure will be described in detail with reference to the drawings. It is to be noted that the description will be given in the following order.
1. First Embodiment (FIGS. 1 to 8H)

An example in which a diffraction grating is provided between an entrance-and-exit surface and a Si layer.
2. Modification Examples of First Embodiment

Modification Example 2-1: An example in which the diffraction grating is in direct contact with the Si layer (FIGS. 9 and 10).

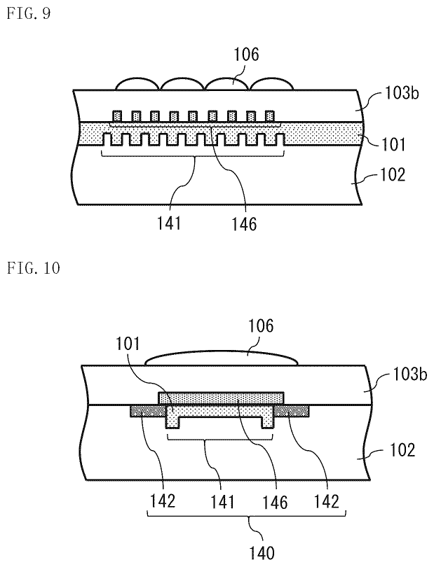

Modification Example 2-2: An example in which the diffraction grating has a height that is several times as large as a depth of the diffraction grating in the Si layer (FIGS. 11 and 12).

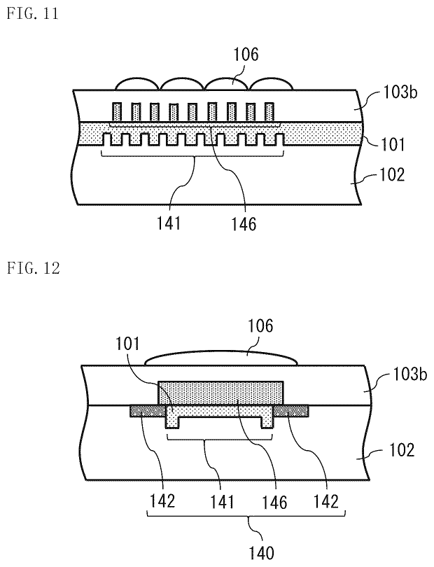

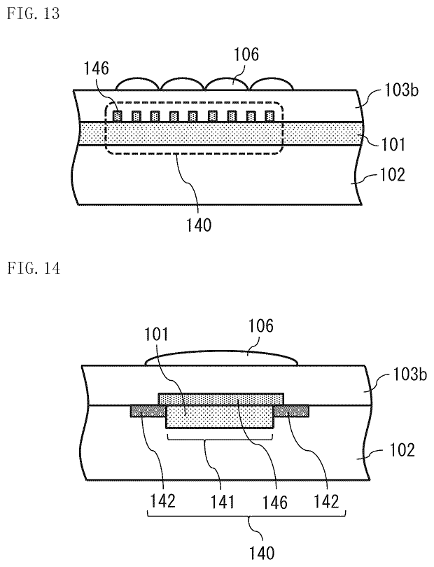

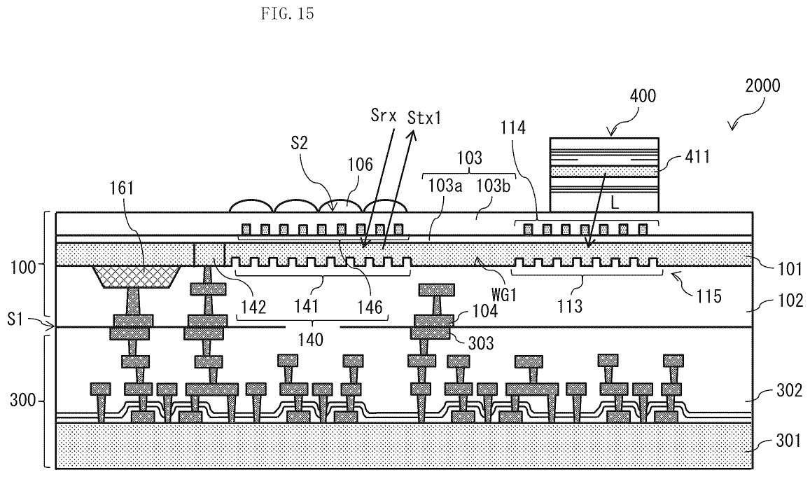

Modification Example 2-3: An example in which the diffraction grating in the Si layer is omitted (FIGS. 13 and 14).
3. Second Embodiment (FIGS. 15 to 17)

An example in which the diffraction grating is provided between a laser chip and the Si layer.
4. Modification Examples of Second Embodiment

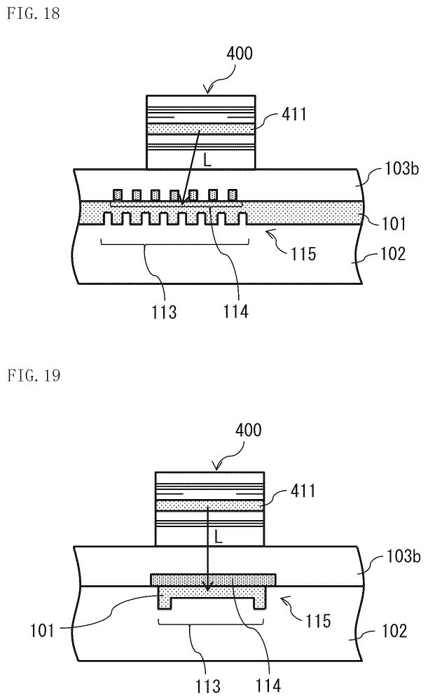

Modification Example 4-1: An example in which the diffraction grating is in direct contact with Si layer (FIGS. 18 and 19).

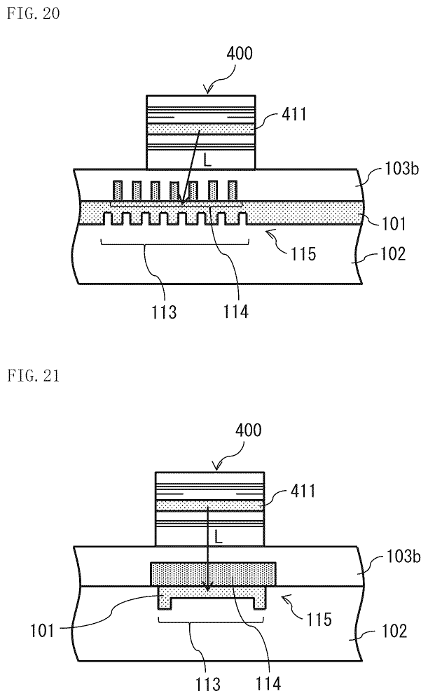

Modification Example 4-2: An example in which the diffraction grating has a height that is several times as large as the depth of the diffraction grating in the Si layer (FIGS. 20 and 21).

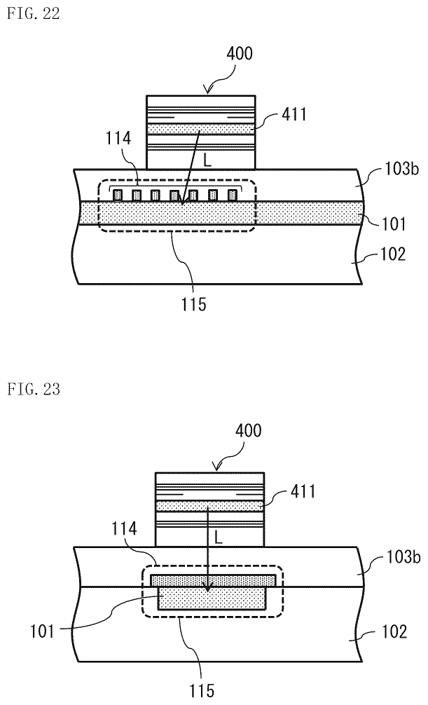

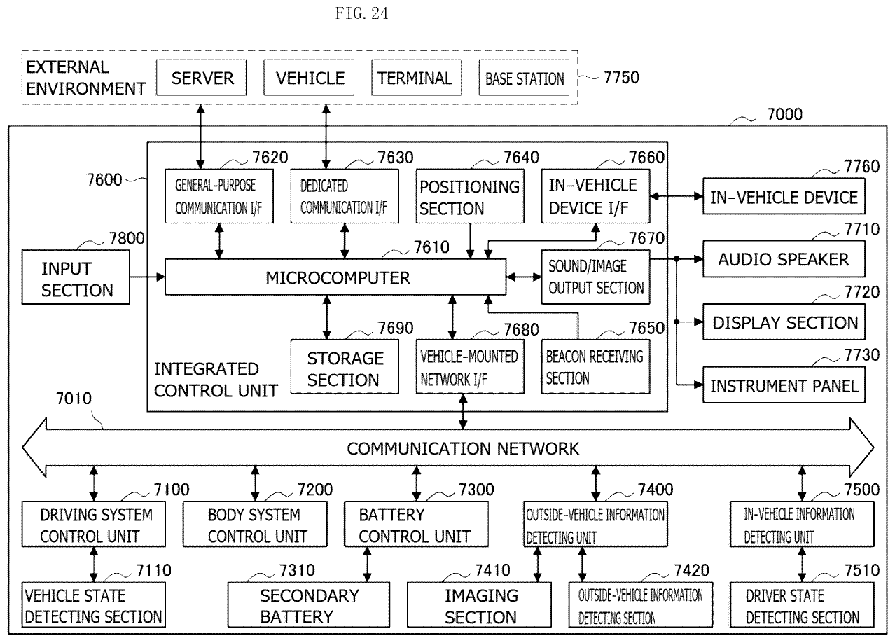

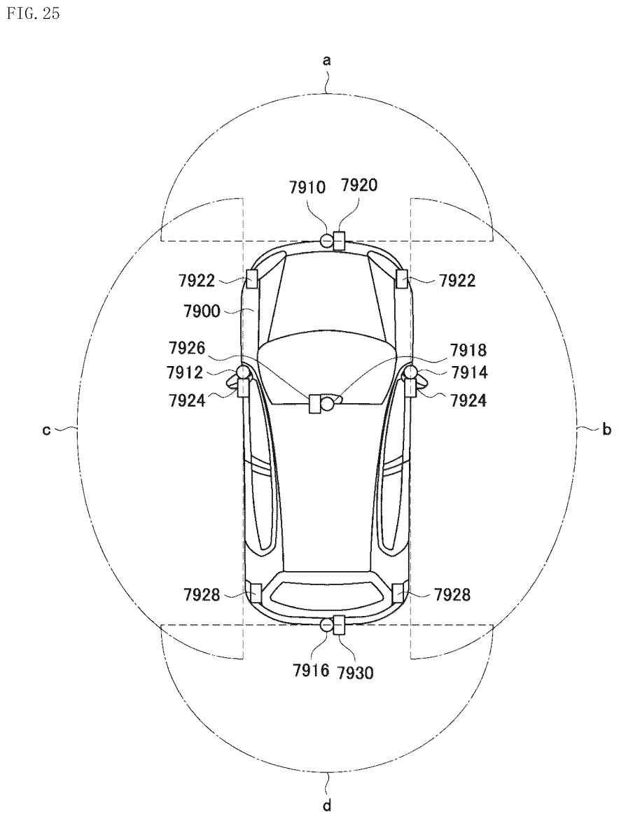

Modification Example 4-3: An example in which the diffraction grating in the Si layer is omitted (FIGS. 22 and 23).
5. Application Examples (FIGS. 24 and 25)

### 1. First Embodiment

### Configuration

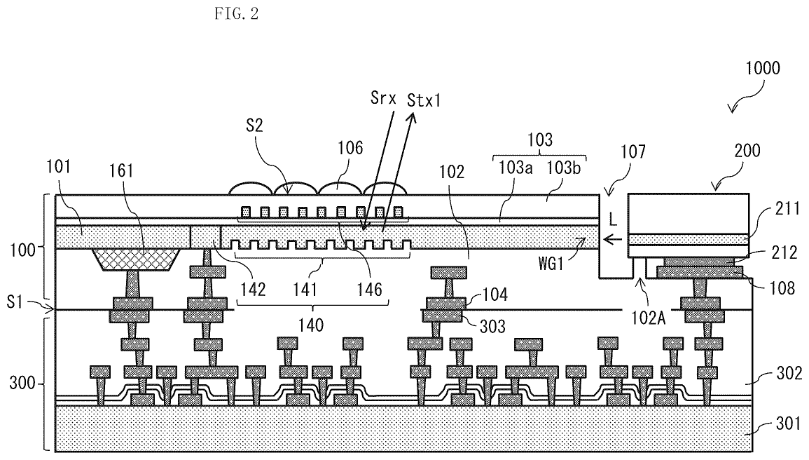

FIG. 1 illustrates an exemplary schematic configuration of a ranging device 1000 according to a first embodiment of the present disclosure. The ranging device 1000 corresponds to a specific example of an “optical receiver” of the present disclosure. FIG. 2 illustrates an exemplary cross-sectional configuration of the ranging device 1000. The ranging device 1000 is a FMCW (Frequency Modulated Continuous Wave) LiDAR. In the FMCW LiDAR, laser light (a transmission signal) so modulated that the frequency increases linearly with a lapse of time is continuously applied, and a distance is obtained from a frequency difference between the transmission signal and reflected light (a return signal).

The ranging device 1000 includes, for example, a PIC substrate 100, a laser chip 200, and a signal processing substrate 300, as illustrated in FIG. 1. For example, as illustrated in FIG. 2, the PIC substrate 100 and the signal processing substrate 300 are stacked on each other and are electrically coupled to each other via a bonding surface S1 between the PIC substrate 100 and the signal processing substrate 300.

### Laser Chip 200

The laser chip 200 is a light source chip configured to generate an optical signal. The laser chip 200 is, for example, a chip-shaped edge-emitting semiconductor laser. The laser chip 200 is configured to output laser light L of a predetermined fixed wavelength (for example, 1550 nm) from an end face of an active layer 211 in accordance with a control performed by a controller 310 to be described later. The laser chip 200 is so mounted on the PIC substrate 100 that the laser light L enters an end face (an optical waveguide WG1 to be described later) of the PIC substrate 100. The laser chip 200 is so mounted on the PIC substrate 100 that an optical spot (the optical spot generated on the end face of the active layer 211) of the laser chip 200 is at the same height as a Si layer 201 (the optical waveguide WG1). The PIC substrate 100 has a cutout part 107. The laser chip 200 is mounted on a coupling pad 108 provided on a bottom surface of the cutout part 107. An electrode of the laser chip 200 and the coupling pad 108 include, for example, Cu (copper), and are joined to each other with a bump 212 interposed therebetween. The bump 212 includes Cu. A protrusion 102A is provided on the bottom surface of the cutout part 107. A top part of the protrusion 102A is in contact with a bottom surface of the laser chip 200. A height of the laser chip 200 is defined by the protrusion 102A.

### PIC Substrate 100

As illustrated in FIG. 1, the PIC substrate 100 includes, for example, a modulator 110, a splitter 120, a circulator 130, an antenna 140, a coupler 150, and a detector 160.

As illustrated in FIG. 2, the PIC substrate 100 includes, for example, a Si layer 101, an interlayer insulating film 102, and an insulating layer 103. The interlayer insulating film 102 and the insulating layer 103 sandwich the Si layer 101. The Si layer 201 is obtained by removing a Si substrate 112 and a BOX (Buried Oxide) layer 111, which will be described later, from a SOI (Silicon on Insulator) substrate. The BOX layer 111 includes a SiO₂ layer. The interlayer insulating film 102 is a layer provided on the SOI substrate. The interlayer insulating film 102 has a configuration in which multiple patterned wiring layers and vias coupling the wiring layers are provided in multiple SiO₂ layers that are stacked. The interlayer insulating film 102 has a surface that serves as a bottom surface of the PIC substrate 100. The surface of the interlayer insulating film 102 is in contact with an upper surface of the signal processing substrate 300 (an interlayer insulating film 302 to be described later). A coupling pad 104 including Cu is exposed on the surface of the interlayer insulating film 102. Meanwhile, a coupling pad 303 including Cu is exposed on the upper surface of the signal processing substrate 300 (the interlayer insulating film 302). The coupling pad 104 and the coupling pad 303 are bonded to each other. Thus, the PIC substrate 100 and the signal processing substrate 300 are bonded to each other at the bottom surface of the PIC substrate 100 and the upper surface of the signal processing substrate 300. In FIG. 2, a bonding surface between the bottom surface of the PIC substrate 100 and the upper surface of the signal processing substrate 300 (the interlayer insulating film 302) is denoted by S1. The interlayer insulating film 102 includes, for example, SiO₂.

The insulating layer 103 is in contact with a surface of the Si layer 101. A surface of the insulating layer 103 serves as an upper surface of the PIC substrate 100 and serves as an entrance-and-exit surface S2. The insulating layer 103 includes, for example, a stacked body including an insulating layer 103a and an insulating layer 103b, as illustrated in FIG. 2. The insulating layer 103a is provided between the Si layer 101 and a diffraction grating 141 to be described later, and is in contact with the Si layer 101 and the diffraction grating 141. The insulating layer 103b is provided between the insulating layer 103a and the entrance-and-exit surface S2, and is in contact with the insulating layer 103a and a diffraction grating 146 to be described later. A surface of the insulating layer 103b is included in the entrance-and-exit surface S2. The insulating layer 103a and the insulating layer 103b include, for example, SiO₂.

The Si layer 101 is provided with optical waveguides WG1, WG2, and WG3 (see FIG. 1). The optical waveguide WG1 extends from an end face of the PIC substrate 100 to the antenna 140 via the modulator 110, the splitter 120, and the circulator 130. The optical waveguide WG2 is an optical waveguide branched from the optical waveguide WG1 at the splitter 120, and is coupled to one (an optical waveguide 151 to be described later) of input terminals of the coupler 150. The optical waveguide WG3 is an optical waveguide branched from the optical waveguide WG1 at the circulator 130, and is coupled to another (an optical waveguide 152 to be described later) of the input terminals of the coupler 150.

The optical waveguide WG1 is configured to transmit the laser light L (the transmission signal) outputted from the laser chip 200. The laser light L outputted from the laser chip 200 enters the optical waveguide WG1. The laser light L that propagates through the optical waveguide WG1 is inputted to the modulator 110. The modulator 110 is configured to modulate a frequency of the laser light L in accordance with a control performed by the controller 310. For example, the modulator 110 is configured to so modulate the laser light L as to linearly increase the frequency with a lapse of time, and thereafter so modulate the laser light L as to linearly decrease the frequency with a lapse of time. For example, the modulator 110 is configured to periodically repeat such linear increase and decrease of the frequency to generate a transmission signal Stx, and output the transmission signal Stx to the splitter 120 via the optical waveguide WG1. The transmission signal Stx is a chirp signal obtained by modulating the frequency of the laser light L by the modulator 110. The modulator 110 is provided in the Si layer 101, for example. The modulator 110 includes, for example, a Mach-Zehnder interferometer in which a Si waveguide is branched into two. In this case, the modulator 110 generates a signal having a changed phase of light by forming a PN junction in one of the branched waveguides and applying a voltage of an alternating current waveform to the PN junction to change a refractive index by the carrier plasma effect. The modulator 110 is configured to modulate the phase of an original signal by multiplexing a generated signal waveform and an original waveform at an exit of the interferometer.

The splitter 120 is configured to split the transmission signal Stx into a transmission signal Stx (a transmission signal Stx1) to be applied to a target TG, and a transmission signal Stx (a transmission signal Stx2) to interfere with a return signal Srx in the coupler 150. The transmission signal Stx1 has most of energy of the transmission signal Stx. The transmission signal Stx2 is a reference signal having an amount of energy that is much smaller than the energy of the transmission signal Stx1, but sufficient to interfere with the return signal Srx in the coupler 150. The return signal Srx corresponds to a signal having a delayed phase in relation to the transmission signal Stx1. The return signal Srx is generated by causing the transmission signal Stx to be reflected by the target TG.

The splitter 120 is an element having three ports. In the splitter 120, a firs port and a third port are present in the optical waveguide WG1. A second port is present in the optical waveguide WG2. The optical waveguide WG2 is disposed in proximity to a part, of the optical waveguide WG1, between the first port and the third port. This causes the optical signal that propagates through the optical waveguide WG1 to leak into the optical waveguide WG2. The optical signal having leaked from the optical waveguide WG1 to the optical waveguide WG2 propagates through the optical waveguide WG2 as the transmission signal Stx2.

The circulator 130 is an element having three ports. In the circulator 130, the transmission signal Stx1 having entered from a first port is transmitted to a third port, and the return signal Srx having entered from the third port is transmitted to a second port. In the circulator 130, the optical waveguide WG1 is coupled to the first port, and the optical waveguide WG2 is coupled to the second port. An optical waveguide extending from the antenna 140 is coupled to the third port. For example, the circulator 130 serves to rectify an optical signal to be transmitted and an optical signal received from the antenna 140. In the circulator 130, signal intensity of each of a transmission signal and a reception signal is divided into 50% and 50% at respective branches by a structure in which an optical waveguide including Si is branched. Handling such half signals makes it possible to separate transmission light and reception light from each other.

The antenna 140 is a non-mechanical scanner having no driver. The antenna 140 transmits the transmission signal Stx1 to the target TG via a lens 106, and receives the return signal Srx via the lens 106. The lens 106 is bonded to a region (the entrance-and-exit surface S2) opposed to the antenna 140 of a surface of the PIC substrate 100. The transmission signal Stx1 is outputted from the entrance-and-exit surface S2, and the return signal Srx enters the entrance-and-exit surface S2. The lens 106 is bonded to the entrance-and-exit surface S2, and the transmission signal Stx is outputted from the antenna 140 to an outside via the lens 106 and the entrance-and-exit surface S2, and the return signal Srx enters the antenna 140 from the outside via the lens 106 and the entrance-and-exit surface S2.

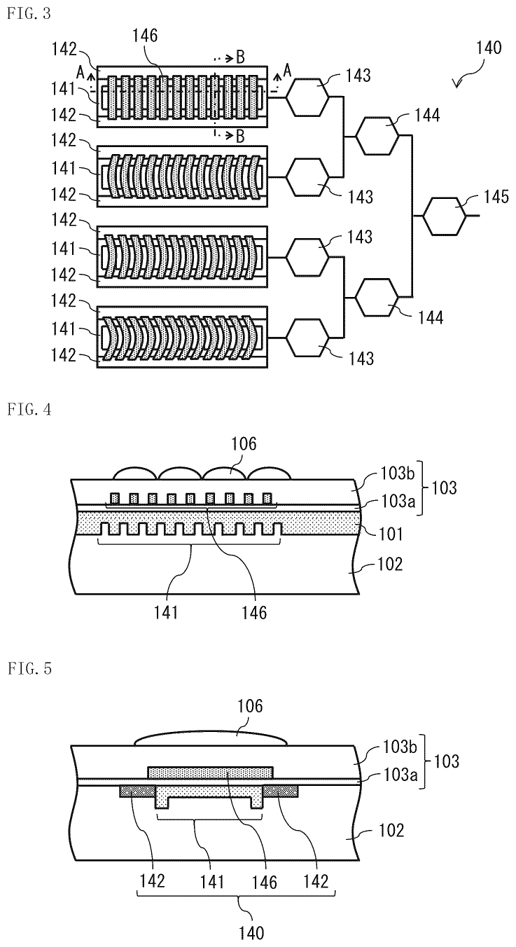

The antenna 140 includes, for example, multiple (for example, four) antenna bodies each including a diffraction grating 141 and a pair of heaters 142, as illustrated in FIG. 3. The diffraction grating 141 is a Si antenna. The pair of heaters 142 are provided on both sides of the diffraction grating 141. The diffraction grating 141 corresponds to a specific example of a “second diffraction grating” according to one embodiment of the present disclosure. The antenna bodies each extend in a common direction, and the multiple antenna bodies are disposed side by side at predetermined intervals in a direction orthogonal to the direction in which the antenna bodies extend. It is to be noted that the heaters 142 may be disposed at respective positions that face each other with a predetermined gap therebetween in a stacking direction of the PIC substrate 100.

The diffraction grating 141 is a diffraction grating provided in the Si layer 101. The diffraction grating 141 is, for example, an element in which multiple grooves are provided side by side in one line on a bottom surface (a surface on the bonding surface S1 side) of the Si layer 101, with a pitch within a range from 50 nm to 500 nm. The diffraction grating 141 outputs the transmission signal Stx1, which has a peak at a certain location corresponding to the pitch of the diffraction grating, to a surface of the Si layer 101 at a predetermined angle, in accordance with a control performed by the controller 310. The heaters 142 each include a resistor element extending along the diffraction grating 141. The heaters 142 each heat the diffraction grating 141 by heat generation of the resistor element caused by application of a current to the resistor element in accordance with a control performed by the controller 310. In the diffraction grating 141, a refractive index is changed by heating by the heaters 152, and the transmission signal Stx1 is outputted at an angle corresponding to a change in the refractive index. In other words, the diffraction grating 141 sweeps the transmission signal Stx1 in a predetermined external region in accordance with a control performed by the controller 310.

In a case where four antenna bodies are provided, the antenna 140 further includes, for example, four optical switches 143 and two optical switches 144, as illustrated in FIG. 3. The four optical switches 143 are each provided for corresponding one of the antenna bodies. The two optical switches 144 are each provided for corresponding two of the optical switches 143. Each of the optical switches 143 is a switch that connects and disconnects an optical waveguide between two terminals (a first terminal and a second terminal). Each of the optical switches 144 is a switch that connects and disconnects an optical waveguide between two terminals (a third terminal and a fourth terminal). The antenna 140 further includes, for example, one optical switch 145 coupled to the two optical switches 144, as illustrated in FIG. 3. Each optical switch 145 is a switch that connects and disconnects an optical waveguide between two terminals (a fifth terminal and a sixth terminal).

In each of the optical switches 143, the first terminal is coupled to the antenna body, and the second terminal is coupled to the second terminal of another optical switch 143 and the third terminal of the optical switch 144. In each of the optical switches 144, the third terminal is coupled to the second terminals of two corresponding optical switches 143, and the fourth terminal is coupled to the fourth terminal of another optical switch 144 and the fifth terminal of the optical switch 145. In the optical switch 145, the fifth terminal is coupled to the fourth terminals of the two optical switches 144, and the sixth terminal is coupled to the second port of the circulator 130.

The antenna bodies each include, for example, the diffraction grating 141 provided on the bottom surface of the Si layer 101, as illustrated in FIGS. 4 and 5. FIG. 4 illustrates an exemplary cross-sectional configuration of the antenna body taken along line A-A in FIG. 3. FIG. 5 illustrates an exemplary cross-sectional configuration of the antenna body taken along line B-B in FIG. 3. The diffraction grating 141 is, for example, an element in which multiple grooves are provided side by side in one line on the bottom surface of the Si layer 101, with a pitch of several hundreds of nanometers, as illustrated in FIGS. 4 and 5. A depth of each of the grooves is, for example, about the same (for example, within a range from 50 nm to 500 nm) as the pitch of the multiple grooves, and a thickness of a part, of the Si layer 101, corresponding to a base of the diffraction grating 141 is, for example, greater than the depth of the groove.

In the diffraction grating 141, the transmission signal Stx1 having a peak at a certain location corresponding to the pitch of the diffraction grating 141 is outputted to the surface (the surface on the entrance-and-exit surface S2 side) of the Si layer 201 at a predetermined angle. The heater 142 includes a resistor element extending along the diffraction grating 141. The heater 142 is configured to heat the diffraction grating 141 by heat generation of the resistor element caused by application of a current to the resistor element in accordance with a control performed by the controller 310. In the diffraction grating 141, the refractive index is changed by heating by the heater 142, and the transmission signal Stx1 is outputted at an angle corresponding to a change in the refractive index.

The antenna 140 is configured to turn on and off the four optical switches 143, the two optical switches 144, and the one switch 145 in accordance with a control performed by the controller 310. The antenna 140 is thus configured to output the transmission signal Stx1 in a predetermined direction from each of the antenna bodies, and to receive the return signal Srx entering from the outside.

As illustrated in FIGS. 2 and 3, the antenna 140 includes, for example, multiple diffraction gratings 146 in a region that is at a location different from the Si layer 101 and is between the Si layer 101 and the entrance-and-exit surface S1. The multiple diffraction gratings 146 are each provided for corresponding one of the antenna bodies. The diffraction grating 146 corresponds to a specific example of a “first diffraction grating” according to one embodiment of the present disclosure. The diffraction grating 141 is provided at a location, in the Si layer 101, opposed to the diffraction grating 146. Each of the diffraction gratings 146 includes, for example, Si or a resin material that is higher in refractive index than the Si layer 101, or has a void provided in the PIC substrate 100 (the insulating layer 103).

As illustrated in FIG. 3, each of the diffraction gratings 146 has a plan shape corresponding to the outputting direction of the transmission signal Stx1. In a case where four antenna bodies are provided, the diffraction grating 146 provided for the first antenna body has, for example, a configuration in which multiple rod-shaped bodies are arranged side by side in a direction parallel to an arrangement direction of the multiple grooves included in the diffraction grating 141. The multiple rod-shaped bodies extend straight in a direction orthogonal to the arrangement direction of the multiple grooves included in the diffraction grating 141. In addition, each of the diffraction gratings 146 provided for the second and the third antennae bodies has, for example, a configuration in which multiple U-shaped rod-shaped bodies are arranged side by side in a direction parallel to the arrangement direction of the multiple grooves included in the diffraction grating 141. The multiple U-shaped rod-shaped bodies are bent in the direction parallel to the arrangement direction of the multiple grooves included in the diffraction grating 141. It is to be noted that the diffraction grating 146 provided for the second antenna body and the diffraction grating 146 provided for the third antenna body are different from each other in the bending direction of the rod-shaped bodies. Further, the diffraction grating 146 provided for the fourth antenna body has, for example, a configuration in which multiple U-shaped rod-shaped bodies are arranged side by side in a direction parallel to the arrangement direction of the multiple grooves included in the diffraction grating 141. The multiple U-shaped rod-shaped bodies are bent in the direction parallel to the arrangement direction of the multiple grooves included in the diffraction grating 141. It is to be noted that in the diffraction grating 146 provided for the fourth antenna body, a curvature of the bending of the rod-shaped bodies is larger than a curvature of the bending of the rod-shaped bodies in the diffraction gratings 146 provided for the second and the third antenna bodies.

The coupler 150 is an element that is configured to generate a beat signal Sbt by interference between the transmission signal Stx2 and the return signal Srx. A frequency of the beat signal Sbt changes in accordance with a frequency difference between the transmission signal Stx2 and the return signal Srx. The frequency difference changes in accordance with a distance from the antenna 140 to the target TG. Accordingly, the distance from the antenna 140 to the target TG may be estimated on the basis of the frequency of the beat signal Sbt.

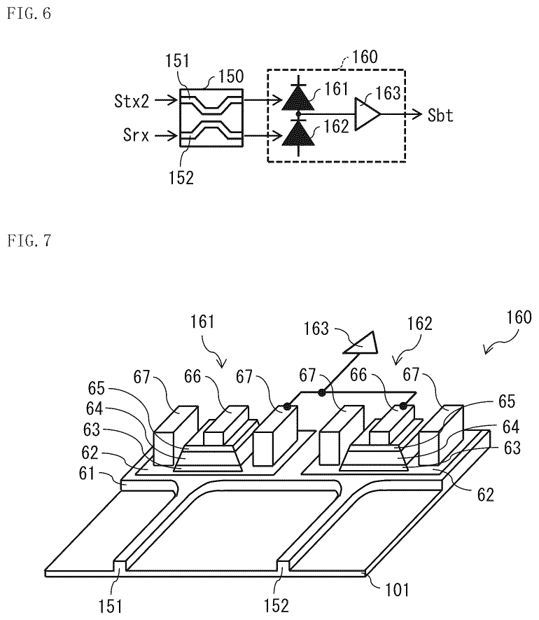

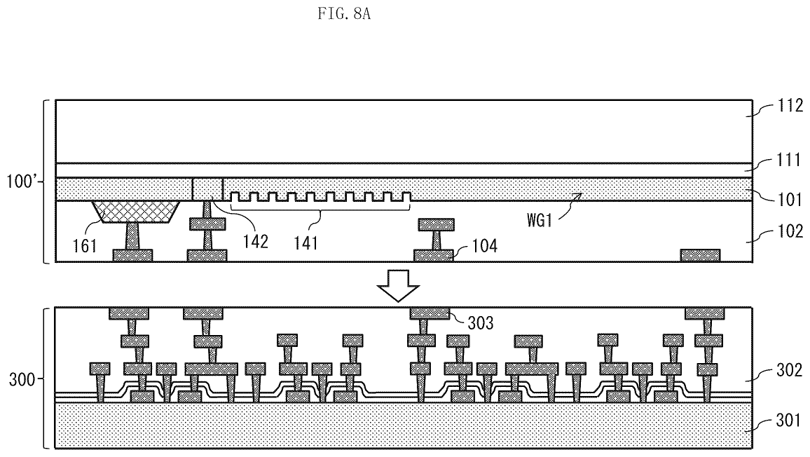

As illustrated in FIG. 6, the coupler 150 includes, for example, the optical waveguide 151 for propagating the transmission signal Stx2, and the optical waveguide 152 for propagating the return signal Srx. Each of the optical waveguides 151 and 152 is, for example, a rib waveguide. A part of the optical waveguide 151 and a part of the optical waveguide 152 are disposed in proximity to each other. This causes the transmission signal Stx2 that propagates through the optical waveguide 151 and the return signal Srx that propagates through the optical waveguide 152 to interfere with each other, thereby generating the beat signal Sbt.

The detector 160 is an element configured to extract the beat signal Sbt from signals having propagated through the optical waveguides 151 and 152. The detector 160 includes, for example, Ge-PDs 161 and 162 that are coupled in series to each other, and a transimpedance amplifier (Transimpedance Amplifier) 163 that is coupled to a coupling node between the Ge-PD 161 and the Ge-PD 162, as illustrated in FIG. 6.

The Ge-PD 161 is, for example, a PIN photodiode coupled to the optical waveguide 151, as illustrated in FIG. 7. The Ge-PD 162 is, for example, a PIN photodiode coupled to the optical waveguide 152, as illustrated in FIG. 7. The Ge-PDs 161 and 162 include, for example, a Si terrace section 61 coupled to the optical waveguides 151 and 152, and a p-type Si layer 62. The p-type Si layer 62 is formed by ion-injecting B into the Si terrace section 61. The Si terrace section 61 and the optical waveguides 151 and 152 are provided in the common Si layer 101.

The Ge-PDs 161 and 162 each further include, for example, an island-shaped i-type Ge layer 63, a two-dimensionally grown i-type Ge layer 64, and an n-type Ge layer 65. The island-shaped i-type Ge layer 63 and the two-dimensionally grown i-type Ge layer 64 are provided on the p-type Si layer 62. The n-type Ge layer 65 is formed by ion-injecting P into the two-dimensionally grown i-type Ge layer 64. A stacked body including the p-type Si layer 62, the island-shaped i-type Ge layer 63, the two-dimensionally grown i-type Ge layer 64, and the n-type Ge layer 65 is included in the PIN photodiode. In the PIN photodiode, the island-shaped i-type Ge layer 63 that is effectively of p-type and does not include a depletion layer has a small thickness, and the two-dimensionally grown i-type Ge layer 64 having a large thickness serves as a depletion layer. This improves sensitivity.

The Ge-PDs 161 and 162 each further include, for example, an n-side electrode 66 in contact with the n-type Ge layer 65, and a p-side electrode 67 in contact with the p-type Si layer 62. The p-side electrode 67 of the Ge-PD 161 and the n-side electrode 66 of the Ge-PD 162 are coupled to each other by a wiring, and the wiring that couples the p-side electrode 67 of the Ge-PD 161 and the n-side electrode 66 of the Ge-PD 162 to each other is coupled to an input terminal of the transimpedance amplifier 163.

The transimpedance amplifier 163 performs impedance conversion and amplification of a current signal photoelectrically converted by the Ge-PDs 161 and 162, and outputs the beat signal Sbt as a voltage signal.

### Signal Processing Substrate 300

The signal processing substrate 300 includes, for example, the controller 310, a DAC 320, an ADC 330, and an FFT (fast Fourier transform) 340, as illustrated in FIG. 1.

The controller 310 is configured to, for example, generate a control signal for controlling the laser chip 200, the modulator 110, the antenna 140, and the detector 160, and output the control signal to the DAC 320. The controller 310 is configured to, for example, further generate a control signal for controlling the ADC 330, and output the control signal to the ADC 330. The DAC 320 is configured to perform DA conversion of the control signal received from the controller 310, and output an analog control signal to the laser chip 200, the modulator 110, the antenna 140, and the detector 160. The ADC 330 is configured to perform AD conversion of the beat signal Sbt received from the detector 160, and output the beat signal Sbt to the FFT 340. The FFT 340 is configured to perform FFT of the beat signal Sbt, which is digital, received from the ADC 330, and on the basis of a power spectrum density obtained thereby, derive the frequency of the beat signal Sbt. The FFT 340 is configured to output information (frequency information) regarding the derived frequency to the controller 310. The controller 310 is configured to output the frequency information received from the FFT 340 to the outside in accordance with a control from the outside.

The signal processing substrate 300 includes, for example, the Si substrate 301, as illustrated in FIG. 2. The Si substrate 301 includes, for example, signal processing circuits including, without limitation, the controller 310, the DAC 320, the ADC 330, and the FFT 340. The interlayer insulating film 302 is provided on the Si substrate 301. The interlayer insulating film 302 has a configuration in which multiple patterned wiring layers and a via that couples the wiring layers to each other are provided in multiple SiO₂ layers that are stacked. A wiring and a via in the signal processing circuits, a wiring and a via for electrically coupling the signal processing circuits to the PIC substrate 100, and the like are provided in the interlayer insulating film 302. The coupling pad 303 including Cu is exposed on the surface of the interlayer insulating film 302, and is bonded to the coupling pad 104 of the PIC substrate 100.

### Manufacturing Method

Next, a description is given of a manufacturing method of the ranging device 1000.

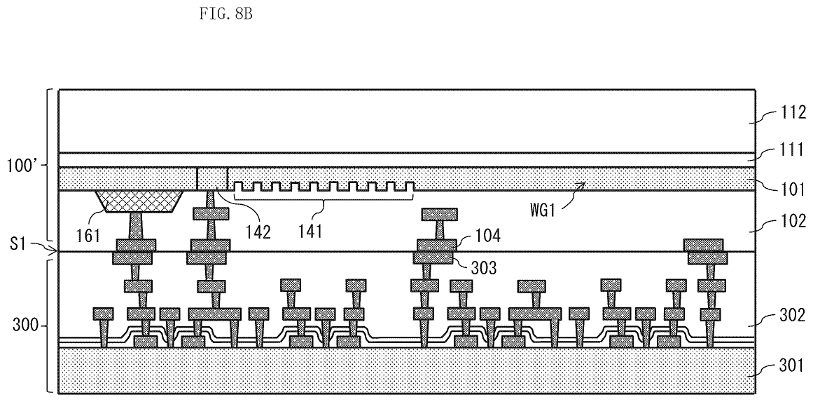

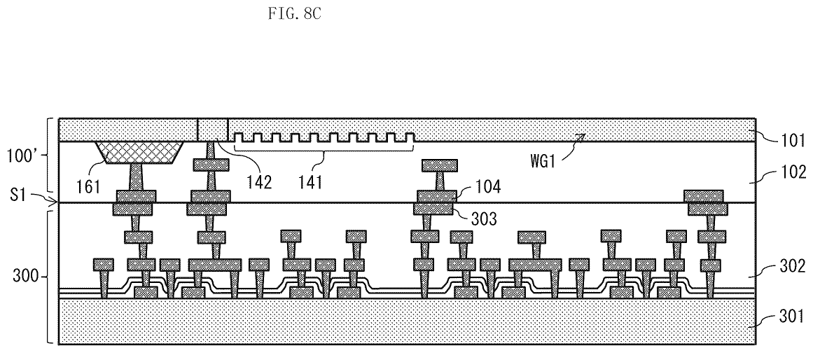

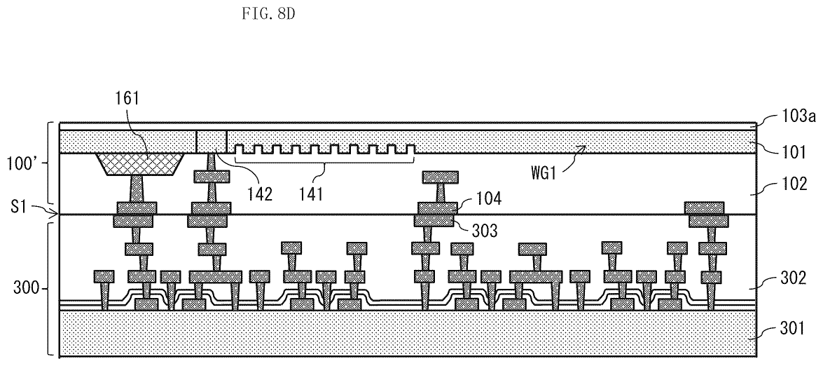

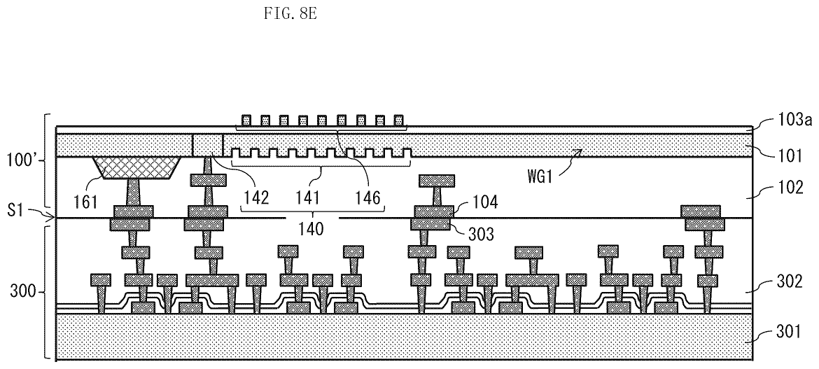

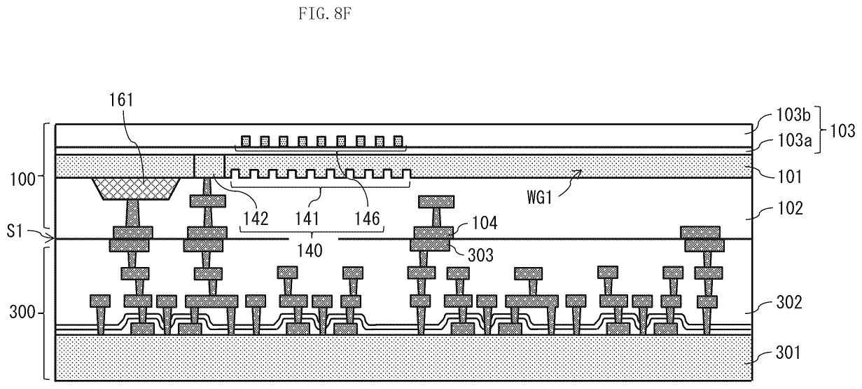

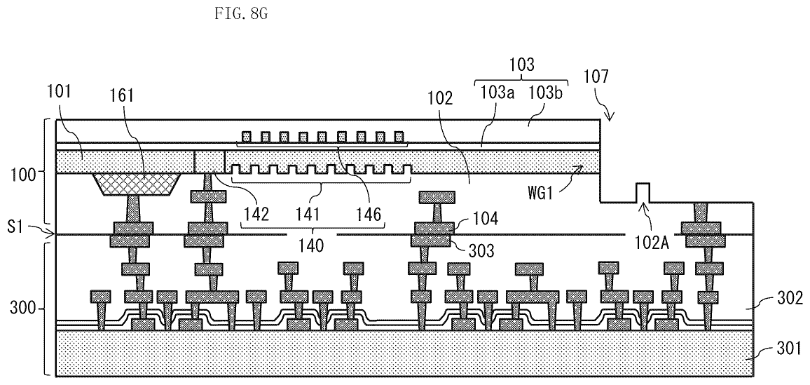

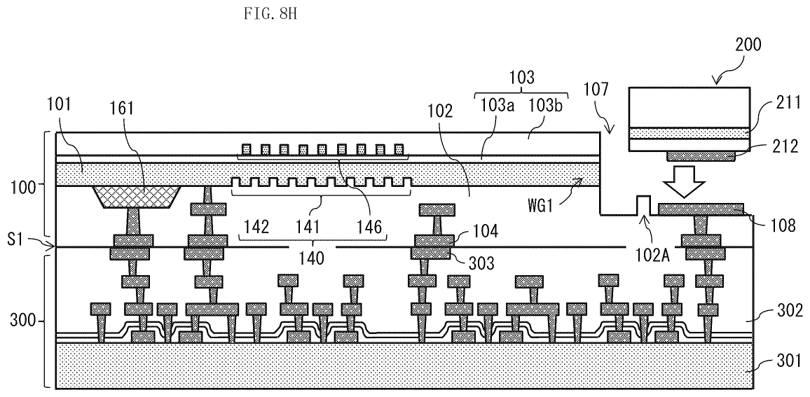

FIGS. 8A to 8H are each a cross-sectional view for describing a process of manufacturing the ranging device 1000. First, the SOI substrate including the Si substrate 112, the BOX layer 11, and the Si layer 101 is prepared. Thereafter, the optical waveguides WG1, WG2, and WG3, the splitter 120, the circulator 130, the antenna 140, the coupler 150, and the detector 160 are formed in the Si layer 101 of the SOI substrate. Thereafter, the interlayer insulating film 102 is formed on the SOI substrate. At this time, the coupling pad 104 is formed in the interlayer insulating film 102. A PIC substrate 100′ is thus formed (FIG. 8A).

Thereafter, the PIC substrate 100′ and the signal processing substrate 300 are bonded to each other with the surface of the interlayer insulating film 102 and the surface of the interlayer insulating film 302 facing each other (FIGS. 8A and 8B). The PIC substrate 100′ and the signal processing substrate 300 are thus electrically coupled to each other. Thereafter, the Si substrate 112 and the BOX layer 111 in the PIC substrate 100′ are removed (FIG. 8C). As a result, the Si layer 101 is exposed. Thereafter, the insulating layer 103a is formed on the surface of the Si layer 101 (FIG. 8D). Thereafter, the diffraction grating 46 is formed on the insulating layer 103a. As a result, the antenna 140 is formed (FIG. 8E). Thereafter, the insulating layer 103b is so formed on a surface of the insulating layer 103a including the diffraction grating 46 as to bury the diffraction grating 46 (FIG. 8F). The PIC substrate 100 is thus formed (FIG. 8F).

Thereafter, the cutout part 107 is formed in the PIC substrate 100 (FIG. 8G). At this time, the protrusion 102A is formed on the bottom surface of the cutout part 107. As a result, a part of the wiring in the interlayer insulating film 102 is exposed on the bottom surface of the cutout part 206. Thereafter, the coupling pad 108 is formed on the wiring exposed on the bottom surface of the cutout part 107, following which the laser chip 200 is mounted with the bump 212 interposed therebetween (FIG. 8H). Lastly, the lens 06 is provided. The ranging device 1000 is thus manufactured.

### Effects

Next, effects of the ranging device 1000 will be described.

In the present embodiment, in the PIC substrate 100, the optical waveguide WG1 and a part of the antenna 140 are provided in the common Si layer 101, and in addition, the diffraction grating 146 is provided in a region, of the antenna 140, that is at a location different from the Si layer 101 and is between the Si layer 101 and the entrance-and-exit surface S2. This allows the diffraction grating 146 and the Si layer 101 to be optically coupled to each other, and allows the transmission signal to be outputted from the Si layer 101 to the outside via the entrance-and-exit surface S2. As a result, it is possible to efficiently output the transmission signal from the Si layer 101 to the outside.

In the present embodiment, the PIC substrate 100 includes the insulating layer 103a between the Si layer 101 and the diffraction grating 146. The insulating layer 103a is in contact with the Si layer 101 and the diffraction grating 146. In addition, the diffraction grating 146 includes Si or a resin material, or has a void. The resin material is higher in refractive index than the Si layer 101. The void is provided in the PIC substrate 100 (the insulating layer 103). This makes it possible to improve adherence between the diffraction grating 146 and the Si layer 101.

In the present embodiment, the diffraction grating 141 is provided at a location, in the Si layer 101, opposed to the diffraction grating 146. This allows the diffraction grating 141 and the diffraction grating 146 to be optically coupled to each other, and allows the transmission signal to be outputted from the Si layer 101 to the outside via the entrance-and-exit surface S2. As a result, it is possible to efficiently output the transmission signal from the Si layer 101 to the outside.

In the present embodiment, the diffraction grating 146 is provided in the ranging device 1000. This makes it possible to apply the transmission signal having a high signal level to the target TG.

In the present embodiment, in the PIC substrate 100, the optical waveguide WG1, the splitter 120, the optical waveguides WG2 and WG3, the coupler 150, and the Ge-PDs 161 and 162 are provided in the common Si layer 101. In addition, the ADC 330 and the detector 270 are provided in the signal processing substrate 300. In addition, the PIC substrate 100 and the signal processing substrate 300 are stacked on each other, and are electrically coupled to each other via the bonding surface S1 between the PIC substrate 100 and the signal processing substrate 300. This makes it possible to achieve a reduction in size as compared with a module in which multiple RF parts are coupled to each other via an optical fiber. The reduction in size shortens the path of the electric signal after the Ge-PDs 161 and 162, which makes it possible to reduce mixing of an external noise into the electric signal.

In the present embodiment, the laser chip 200 is mounted on the PIC substrate 100, and the controller 310 that controls the laser chip 200, the modulator 110, and the antenna 140 is provided in the signal processing substrate 300. This makes it possible to achieve a reduction in size as compared with a module in which multiple RF parts are coupled to each other via an optical fiber. The reduction in size shortens the transfer path of the laser light L, which makes it possible to reduce loss of the laser light L.

In the present embodiment, the PIC substrate 100 and the signal processing substrate 300 are electrically coupled to each other by bonding the coupling pads 104 and 303 provided on the bonding surface S1 between the PIC substrate 100 and the signal processing substrate 300. This makes it possible to achieve a reduction in size as compared with a module in which multiple RF parts are coupled to each other via an optical fiber. In addition, an effect of increasing quantum efficiency by reflection at the coupling pads 104 and 303 is expectable.

In the present embodiment, the laser chip 200 is an edge-emitting laser, and is so mounted on the PIC substrate 100 that the optical spot of the laser chip 200 is at the same height as the Si layer 101 (the optical waveguide WG1). The laser chip 200 inputs an optical signal to the modulator 110 via the end face of the optical waveguide WG1. This makes it possible to achieve a reduction in size as compared with a module in which multiple RF parts are coupled to each other via an optical fiber.

In the present embodiment, the laser chip 200 and the signal processing substrate 300 are electrically coupled to each other via the bump 212 provided between the laser chip 200 and the signal processing substrate 300. Accordingly, it is possible to perform positioning of the laser chip 200 with high accuracy.

### 2. Modification Examples of First Embodiment

Next, modification examples of the ranging device 1000 will be described.

### Modification Example 2-1

FIGS. 9 and 10 each illustrate a modification example of the cross-sectional configuration of the antenna 140 in the ranging device 1000. FIG. 9 illustrates a modification example of the cross-sectional configuration in FIG. 4, and FIG. 10 illustrates a modification example of the cross-sectional configuration in FIG. 5. In the embodiment described above, the insulating layer 103a may be omitted, and the diffraction grating 146 may be in direct contact with the Si layer 101. In this case, the diffraction grating 146 includes, for example, a resin material that is higher in refractive index than the Si layer 101, or has a void provided in the PIC substrate 1000 (the insulating layer 103b). In a case where the diffraction grating 146 thus includes a material that has a less possibility of falling off from the Si layer 101, it is possible to increase strength of the optical coupling between the diffraction grating 141 and the diffraction grating 146 by omitting the insulating layer 103a. As a result, it is possible to efficiently output the transmission signal to the outside from the Si layer 101.

### Modification Example 2-2

FIGS. 11 and 12 each illustrate a modification example of the cross-sectional configuration of the antenna 140 in the ranging device 1000. FIG. 11 illustrates a modification example of the cross-sectional configuration in FIG. 4, and FIG. 12 illustrates a modification example of the cross-sectional configuration in FIG. 5. In the embodiment and the modification example thereof described above, the diffraction grating 146 may have a thickness that is several or more times as large as the depth of the groove included in the diffraction grating 141. It is to be noted that FIGS. 11 and 12 each illustrate an example in which the insulating layer 103a is omitted. In such a case, it is possible to increase the strength of the optical coupling between the diffraction grating 141 and the diffraction grating 146. As a result, it is possible to efficiently output the transmission signal from the Si layer 101 to the outside.

### Modification Example 2-3

FIGS. 13 and 14 each illustrate a modification example of the cross-sectional configuration of the antenna 140 in the ranging device 1000. FIG. 13 illustrates a modification example of the cross-sectional configuration in FIG. 4, and FIG. 14 illustrates a modification example of the cross-sectional configuration in FIG. 5. In the embodiment and the modification examples thereof described above, the diffraction grating 141 may be omitted. It is to be noted that FIGS. 13 and 14 each illustrate an example in which the insulating layer 103a is omitted. In such a case also, it is possible to allow the Si layer 101 and the diffraction grating 146 to be optically coupled to each other. As a result, it is possible to efficiently output the transmission signal from the Si layer 101 to the outside.

### 3. Second Embodiment

### Configuration

FIG. 15 illustrates an exemplary cross-sectional configuration of a ranging device 2000 according to a second embodiment of the present disclosure. For example, as illustrated in FIG. 15, the ranging device 2000 has a configuration in which a surface-emitting laser chip 400 is provided in the ranging device 1000, instead of the edge-emitting laser chip 200. Further, as illustrated in FIG. 15, the ranging device 2000 has, for example, a configuration in which an optical coupling part 115 is provided at a location, in the PIC substrate 100, opposed to the laser chip 400 in the ranging device 1000.

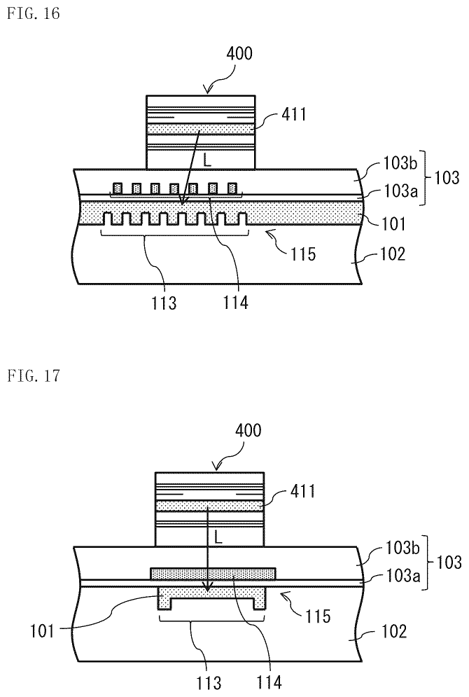

FIGS. 16 and 17 each illustrate an exemplary cross-sectional configuration of the optical coupling part 115 in the ranging device 2000. FIG. 16 illustrates an exemplary cross-sectional configuration in the ranging device 2000, corresponding to the cross-sectional position in FIG. 4, and FIG. 17 illustrates an exemplary cross-sectional configuration in the ranging device 2000, corresponding to the cross-sectional position in FIG. 5.

The laser chip 400 is a light source chip configured to generate an optical signal. The laser chip 400 is, for example, a chip-shaped vertical-cavity surface-emitting laser (VCSEL; Vertical Cavity Surface Emitting Laser). As illustrated in FIG. 15, the laser chip 400 is configured to include, for example, an active layer 411 and a pair of DBR (distributed Bragg reflector) layers sandwiching the active layer 411 from the thickness direction, and is configured to output the laser light L from a bottom surface of the laser chip 400. For example, the laser chip 400 is configured to output the laser light L having a predetermined fixed wavelength (for example, 1550 nm) from the active layer 411 in accordance with a control performed by the controller 310. The laser chip 400 is so mounted on the upper surface of PIC substrate 100 that the laser light L enters the upper surface (the optical waveguide WG1) of the PIC substrate 100. For example, the laser chip 400 is configured to cause the laser light L to obliquely enter the upper surface of the optical waveguide WG1.

The optical coupling part 115 is configured to guide the laser light L outputted from the laser chip 400 to the optical waveguide WG1. For example, as illustrated in FIG. 15, the optical coupling part 115 includes two diffraction gratings 113 and 114.

The diffraction grating 113 is a diffraction grating provided in the Si layer 101. The diffraction grating 113 is provided at a location, in the Si layer 101, opposed to the diffraction grating 114 and the laser chip 400. The diffraction grating 113 is, for example, an element in which multiple grooves are provided side by side in one line on the bottom surface (the surface on the bonding surface S1 side) of the Si layer 101 with a pitch within a range from 50 nm to 500 nm. The grooves have a depth, for example, approximately equal to the pitch (for example, within the range from 50 nm to 500 nm) of the multiple grooves. A thickness of a part, of the Si layer 101, corresponding to a base of the diffraction grating 113 is, for example, larger than the depth of the grooves.

The diffraction grating 114 is provided in a region between the Si layer 101 and the laser chip 400. The diffraction grating 114 is provided in the insulating layer 103 and is in contact with the surface of the insulating layer 103a. The diffraction grating 114 has, for example, a configuration in which multiple U-shaped rod-shaped bodies are arranged side by side in a direction parallel to the arrangement direction of the multiple grooves included in the diffraction grating 113. The multiple U-shaped rod-shaped bodies are bent in the direction parallel to the arrangement direction of the multiple grooves included in the diffraction grating 113. For example, in a plan view, a traveling direction of the laser light L outputted from the laser chip 400 and a bending direction of the multiple rod-shaped members included in the diffraction grating 114 are the same as each other. Each of the diffraction gratings 114 includes, for example, Si or a resin material that is higher in refractive index than the Si layer 101, or has a void provided in the PIC substrate 100 (the insulating layer 103).

### Effects

In the present embodiment, in the PIC substrate 100, the optical waveguide WG1 and the diffraction grating 113 are provided in the common Si layer 101. In addition, the diffraction grating 114 is provided in the region between the Si layer 101 and the laser chip 400. This allows the diffraction grating 114 and the Si layer 101 to be optically coupled to each other, and allows the laser light L to be guided to the Si layer 101. As a result, it is possible to efficiently guide the laser light L to the Si layer 101.

In the present embodiment, in the PIC substrate 100, the insulating layer 103a in contact with the Si layer 101 and the diffraction grating 114 is provided between the Si layer 101 and the diffraction grating 114. In addition, the diffraction grating 114 includes Si or the resin material that is higher in refractive index than the Si layer 101, or has the void provided in the PIC substrate 100 (the insulating layer 103). This makes it possible to improve adherence between the diffraction grating 114 and the Si layer 101.

In the present embodiment, the diffraction grating 113 is provided at a location, in the Si layer 101, opposed to the diffraction grating 114. This allows the diffraction grating 113 and the diffraction grating 114 to be optically coupled to each other, and allows the laser light L to be guided to the Si layer 101. As a result, it is possible to efficiently guide the laser light L to the Si layer 101.

### 4. Modification Examples of Second Embodiment

Next, modification examples of the ranging device 2000 will be described.

### Modification Example 4-1

FIGS. 18 and 19 each illustrate a modification example of the cross-sectional configuration of the optical coupling part 115 in the ranging device 2000. FIG. 18 illustrates a modification example of the cross-sectional configuration, in the ranging device 2000, at a position corresponding to the cross-sectional position in FIG. 4, and FIG. 19 illustrates a modification example of the cross-sectional configuration, in the ranging device 2000, at a position corresponding to the cross-sectional position in FIG. 5. In the second embodiment described above, the insulating layer 103a may be omitted, and the diffraction grating 114 may be in direct contact with the Si layer 101. In this case, the diffraction grating 114 includes, for example, a resin material that is higher in refractive index than the Si layer 101, or has a void provided in the PIC substrate 1000 (the insulating layer 103b). In a case where the diffraction grating 114 thus includes a material that has a less possibility of falling off from the Si layer 101, it is possible to increase strength of the optical coupling between the diffraction grating 113 and the diffraction grating 114 by omitting the insulating layer 103a. As a result, it is possible to efficiently guide the laser light L to the Si layer 101.

### Modification Example 4-2

FIGS. 20 and 21 each illustrate a modification example of the cross-sectional configuration of the optical coupling part 115 in the ranging device 2000. FIG. 20 illustrates a modification example of the cross-sectional configuration, in the ranging device 2000, at a position corresponding to the cross-sectional position in FIG. 4, and FIG. 21 illustrates a modification example of the cross-sectional configuration, in the ranging device 2000, at a position corresponding to the cross-sectional position in FIG. 5. In the second embodiment and the modification example thereof described above, the diffraction grating 114 may have a thickness that is several times or more as large as the depth of the groove included in the diffraction grating 141. It is to be noted that FIGS. 20 and 21 each illustrate an example in which the insulating layer 103a is omitted. In such a case, it is possible to increase the strength of the optical coupling between the diffraction grating 113 and the diffraction grating 114. As a result, it is possible to efficiently guide the laser light L to the Si layer 101.

### Modification Example 4-3

FIGS. 22 and 23 each illustrate a modification example of the cross-sectional configuration of the optical coupling part 115 in the ranging device 2000. FIG. 22 illustrates a modification example of the cross-sectional configuration, in the ranging device 2000, at a position corresponding to the cross-sectional position in FIG. 4, and FIG. 23 illustrates a modification example of the cross-sectional configuration, in the ranging device 2000, at a position corresponding to the cross-sectional position in FIG. 5. In the second embodiment and the modification examples thereof described above, the diffraction grating 113 may be omitted. It is to be noted that FIGS. 22 and 23 each illustrate an example in which the insulating layer 103a is omitted. In such a case also, it is possible to allow the Si layer 101 and the diffraction grating 114 to be optically coupled to each other. As a result, it is possible to efficiently guide the laser light L to the Si layer 101.

### 5. Application Examples

The technique according to the present disclosure is applicable to various products. For example, the technique according to the present disclosure may be achieved in the form of a device to be mounted on a mobile body of any kind such as an automobile, an electric vehicle, a hybrid electric vehicle, a motorcycle, a bicycle, a personal mobility device, an airplane, a drone, a vessel, a robot, a construction machine, or an agricultural machine (tractor).

FIG. 24 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 24, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay, or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 24 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

FIG. 25 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 25 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 24, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM), worldwide interoperability for microwave access (WiMAX), long term evolution (LTE)), LTE-advanced (LTE-A), or the like, or another wireless communication protocol such as wireless LAN (referred to also as wireless fidelity (Wi-Fi), Bluetooth, or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth, near field communication (NFC), or wireless universal serial bus (WUSB). In addition, the in-vehicle device I/F 7660 may establish wired connection by universal serial bus (USB), high-definition multimedia interface (HDMI), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 24, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 24 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

It is to be noted that it is possible to provide a computer program for implementing each function of any of the ranging devices described with reference to FIGS. 1 to 23 in any control unit or the like. In addition, it is also possible to provide a computer-readable recording medium in which such a computer program is stored. The recording medium is, for example, a magnetic disk, an optical disk, a magneto-optical disk, a flash memory, or the like. In addition, the computer program described above may be distributed, for example, through a network without using a recording medium.

It is possible for the vehicle control system 7000 described above to use any of the ranging devices described with reference to FIGS. 1 to 23, for example, as a light source steering section of an LIDAR as an environmental sensor. In addition, the image recognition in the imaging unit may be performed by an optical computing unit using any of the ranging devices described with reference to FIGS. 1 to 23. In a case where any of the ranging devices described with reference to FIGS. 1 to 23 is used as a projection device with high efficiency and high brightness, it is possible to project a line or a character on the ground. Specifically, it is possible, for example, to so display a line as to allow a person outside the vehicle to recognize a position where the vehicle passes when the vehicle moves backward, or to display a crosswalk with light in a case of letting the pedestrian go first.

In addition, at least some of components of any of the ranging devices described with reference to FIGS. 1 to 23 may be implemented in a module (for example, an integrated circuit module included in one die) for the integrated control unit 7600 illustrated in FIG. 24. Alternatively, any of the ranging devices described with reference to FIGS. 1 to 23 may be implemented by the multiple control units of the vehicle control system 7000 illustrated in FIG. 24.

In addition, at least some of components of any of the ranging devices described with reference to FIGS. 1 to 23 may be implemented in a module (for example, an integrated circuit module included in one die) for the integrated control unit 7600 illustrated in FIG. 24. Alternatively, any of the ranging devices described with reference to FIGS. 1 to 23 may be implemented by the multiple control units of the vehicle control system 7000 illustrated in FIG. 24.

Although the present disclosure has been described above with reference to the some embodiments and the modification examples thereof, the present disclosure is not limited to the embodiments and the like described above, and may be modified in a variety of ways. It is to be noted that the effects described herein are merely illustrative. The effects of the present disclosure are not limited to the effects described herein. The present disclosure may have effects other than the effects described herein.

In addition, the present disclosure may have any of the following configurations, for example.
(1)

An optical receiver including:
a PIC (Photonic Integration Circuit) substrate that includes a first waveguide and an antenna and in which the first waveguide and a part of the antenna are provided in a common Si (Silicon) layer, and in addition, an entrance-and-exit surface is provided at a location opposed to the antenna, the first waveguide being configured to transmit a transmission signal, the antenna being configured to output the transmission signal to an outside via the entrance-and-exit surface and to receive a return signal from the outside via the entrance-and-exit surface; and
a signal processing substrate configured to process a signal generated on the basis of the return signal, in which
the PIC substrate and the signal processing substrate are stacked on each other and are electrically coupled to each other via a joining surface between the PIC substrate and the signal processing substrate, and
the antenna includes a first diffraction grating provided in a region between the Si layer and the entrance-and-exit surface.
(2)

The optical receiver according to (1), in which
the PIC substrate includes an insulating layer between the Si layer and the first diffraction grating, the insulating layer being in contact with the Si layer and the first diffraction grating, and
the first diffraction grating includes Si or a resin material, or has a void, the resin material being higher in refractive index than the Si layer, the void being provided in the PIC substrate.
(3)

The optical receiver according to (1), in which
the first diffraction grating is in direct contact with the Si layer, and
the first diffraction grating includes a resin material or has a void, the resin material being higher in refractive index than the Si layer, the void being provided in the PIC substrate.
(4)

The optical receiver according to any one of (1) to (3), in which the antenna further includes a second diffraction grating at a location, in the Si layer, opposed to the first diffraction grating.
(5)

The optical receiver according to any one of (1) to (4), further including
a light source unit configured to output an optical signal, in which
the PIC substrate further includes
   a modulator configured to generate a chirp signal by modulating a frequency of the optical signal,
   a splitter configured to split the chirp signal into the transmission signal and a reference signal,
   a second waveguide configured to transmit the return signal, and
   a signal generator configured to generate a beat signal on the basis of the reference signal and the return signal,
the modulator, the splitter, the second waveguide, and the signal generator are provided in the Si layer, and
the signal processing substrate includes
   a converter configured to perform AD conversion on the beat signal,
   a signal processor configured to process the beat signal being digital and generated by the converter, and
   a controller configured to control the light source unit, the modulator, and the signal generator.
(6)

A ranging device including:
a light source unit configured to output an optical signal;
a PIC (Photonic Integration Circuit) substrate that includes a first waveguide and an optical coupling part and in which the first waveguide and a part of the optical coupling part are provided in a common Si layer, and in addition, the entrance surface is provided at a location opposed to the optical coupling part, the first waveguide being configured to transmit the optical signal, the optical coupling part being configured to guide the optical signal to the first waveguide; and
a signal processing substrate configured to process a signal generated on the basis of the optical signal, in which
the PIC substrate and the signal processing substrate are stacked on each other and are electrically coupled to each other via a joining surface between the PIC substrate and the signal processing substrate, and
the optical coupling part includes a first diffraction grating provided in a region between the Si layer and the entrance surface.
(7)

The ranging device according to (6), in which
the PIC substrate includes an insulating layer between the Si layer and the first diffraction grating, the insulating layer being in contact with the Si layer and the first diffraction grating, and
the first diffraction grating includes Si or a resin material, or has a void, the resin material being higher in refractive index than the Si layer, the void being provided in the PIC substrate.
(8)

The ranging device according to (6), in which
the first diffraction grating is in direct contact with the Si layer, and
the first diffraction grating includes a resin material or has a void, the resin material being higher in refractive index than the Si layer, the void being provided in the PIC substrate.
(9)

The ranging device according to (6), in which the optical coupling part further includes a second diffraction grating at a location, in the Si layer, opposed to the first diffraction grating.

In an optical receiver according to an embodiment of the present disclosure, in a PIC substrate, a first waveguide and a part of an antenna are provided in a common Si layer. In addition, a diffraction grating is provided in a region that is at a location, in the antenna, different from the Si layer and is between the Si layer and an entrance-and-exit surface. This allows the diffraction grating and the Si layer to be optically coupled to each other, and allows a transmission signal to be outputted from the Si layer to an outside via the entrance-and-exit surface. As a result, it is possible to efficiently output the transmission signal from the Si layer to the outside.

This application claims the benefit of Japanese Priority Patent Application JP 2023-089847 filed on May 31, 2023 the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical receiver, comprising:
a PIC (Photonic Integration Circuit) substrate that includes a first waveguide and an antenna and in which the first waveguide and a part of the antenna are provided in a common Si (Silicon) layer, and in addition, an entrance-and-exit surface is provided at a location opposed to the antenna, the first waveguide being configured to transmit a transmission signal, the antenna being configured to output the transmission signal to an outside via the entrance-and-exit surface and to receive a return signal from the outside via the entrance-and-exit surface; and
a signal processing substrate configured to process a signal generated on a basis of the return signal, wherein
the PIC substrate and the signal processing substrate are stacked on each other and are electrically coupled to each other via a joining surface between the PIC substrate and the signal processing substrate, and
the antenna includes a first diffraction grating provided in a region between the Si layer and the entrance-and-exit surface.

2. The optical receiver according to claim 1, wherein
the PIC substrate includes an insulating layer between the Si layer and the first diffraction grating, the insulating layer being in contact with the Si layer and the first diffraction grating, and
the first diffraction grating includes Si or a resin material, or has a void, the resin material being higher in refractive index than the Si layer, the void being provided in the PIC substrate.

3. The optical receiver according to claim 1, wherein
the first diffraction grating is in direct contact with the Si layer, and
the first diffraction grating includes a resin material or has a void, the resin material being higher in refractive index than the Si layer, the void being provided in the PIC substrate.

4. The optical receiver according to claim 1, wherein the antenna further includes a second diffraction grating at a location, in the Si layer, opposed to the first diffraction grating.

5. The optical receiver according to claim 1, further comprising
a light source unit configured to output an optical signal, wherein
the PIC substrate further includes
a modulator configured to generate a chirp signal by modulating a frequency of the optical signal,
a splitter configured to split the chirp signal into the transmission signal and a reference signal,
a second waveguide configured to transmit the return signal, and
a signal generator configured to generate a beat signal on a basis of the reference signal and the return signal,
the modulator, the splitter, the second waveguide, and the signal generator are provided in the Si layer, and
the signal processing substrate includes
a converter configured to perform AD conversion on the beat signal,
a signal processor configured to process the beat signal being digital and generated by the converter, and
a controller configured to control the light source unit, the modulator, and the signal generator.
